(19) United States
(12) Patent Application Publication
(10) Pub. No.: US 2013/0217371 A1
(43) Pub. Date: Aug. 22, 2013

(54) NAVIGATION DEVICE AND METHOD FOR ANSWERING PERSONAL TRAVELING INFORMATION

(71) Applicants: MITAC INTERNATIONAL CORP., (US); MITAC INNOVATION (KUNSHAN) LTD., (US)

(72) Inventors: CELERY ZHANG, Kunshan (CN); ASIA YU, Kunshan (CN)

(73) Assignees: MITAC INNOVATION (KUNSHAN) LTD., Kunshan (CN); MITAC INTERNATIONAL CORP., TAOYUAN COUNTY (TW)

(21) Appl. No.: 13/753,088

(22) Filed: Jan. 29, 2013

(30) Foreign Application Priority Data
Feb. 22, 2012 (CN) 201210039822.1

(51) Int. Cl. H04W 4/02

(52) U.S. Cl. CPC H04W 4/025
USPC 455/415; 455/456.2

(57) ABSTRACT

A navigation device and a method for answering personal traveling information are disclosed. The navigation device is connected to a portable electronic device. The navigation device includes a transmission module, an information capturing module, an incoming call detection module and a processing module, wherein the transmission module receives incoming call information of an incoming caller generated by the portable electronic device. The incoming call detection module detects the incoming call signal generated by the portable electronic device. The information capturing module captures navigation information of the navigation device. The processing module analyzes the incoming call signal to correspondingly obtain incoming caller information. When the incoming call detection module detects the incoming call information generated by the portable electronic device, the processing module determines whether or not navigation information is transformed into a traveling message based upon incoming caller information so that traveling message is transmitted to the incoming caller.

### CROSS-REFERENCE TO RELATED APPLICATION

This application claims the benefit of China Patent Application No. 201210039822.1, filed on Feb. 22, 2012, in the State Intellectual Property Office of the People's Republic of China, the disclosure of which is incorporated herein in its entirety by reference.

### BACKGROUND OF THE INVENTION

1. Field of the Invention

The present invention relates to a navigation device, and more particularly to a navigation device and method for answering personal traveling information capable of making automatic replies for a driver with respect to current state and navigation information when a cell phone comes.

2. Description of the Related Art

In many cases of traffic accidents caused by mobile phones, these accidents usually occur in a moment of operating the mobile phone to answer phone calls while driving automobiles. Further, although a driver is looking ahead, he/she still answers that phone, resulting in distraction from driving. Meanwhile, according to the overseas research, when the driver drives the automobile and answers the mobile phone, the reaction becomes slower in case of emergency. Therefore, the driver answering the incoming call is quite a dangerous behavior.

To increase the safety, the driver may usually hang up the call and return the call after parking at a roadside or safety places. When an incoming caller urgently needs to know the driver's current condition, the incoming caller continuously makes calls. If the driver rejects these calls, not only is the temper of the incoming caller is affected, but also the mood of the driver is influenced to endanger the driving safety.

Therefore, designing a navigation device and a method for answering personal traveling information to allow the driver to focus on driving and to allow the incoming caller to obtain the current condition of the driver without the driver answering the phone becomes an important issue in market applications

### SUMMARY OF THE INVENTION

In view of the shortcomings of the prior art, the inventor(s) of the present invention based on years of experience in the related industry to conduct extensive researches and experiments, and finally developed a navigation and method for answering personal traveling information as a principle objective so that a driver does not need to answer the phone to allow an incoming caller to be aware the current condition of the driver.

To achieve the foregoing objective of the invention, a navigation device is provided and connected to a portable electronic device. The navigation device includes a transmission module, an incoming call detection module, an information capturing module and a processing module. The transmission module is used for receiving an incoming call signal of an incoming caller generated by the portable electronic device. The incoming call detection module can detect the incoming call signal generated by the portable electronic device. The information capturing module captures navigation information of the navigation device. The processing module is electronically connected to the information capturing module and the transmission module and analyzes the incoming call signal to correspondingly obtain incoming caller information. When the incoming call detection module detects the incoming call signal generated by the portable electronic device, the processing module determines whether or not the navigation information is transformed into a traveling message based upon the incoming caller information so that the traveling message is transmitted to the incoming caller.

The navigation device further includes a storage module for storing incoming caller information.

When the navigation device is connected to the portable electronic device, the information capturing module captures a phone address book of the portable electronic device, and the book is transmitted to the storage module to update incoming caller information.

The navigation device further comprises a setting module for setting a classification group or a transmission permission of incoming caller information.

The processing module determines whether or not the traveling message is transmitted according to the classification group of the incoming caller information.

The processing module determines whether or not the traveling message is transmitted according to the transmission permission.

The traveling message is a script message, a figure message, a motion picture message, an audio message or a video message.

The navigation information includes a current location, a navigation starting point, a navigation destination or an estimated arrival time.

According to the objective of the invention, a method for answering personal traveling information is provided and suitable for a navigation device. The navigation device includes a transmission module, an information capturing module, an incoming call detection module and a processing module. The navigation device is connected to a portable electronic device. The method for answering personal traveling information comprises the following steps: receiving an incoming call signal of an incoming caller generated by the portable electronic device through the transmission module; detecting whether or not the incoming call signal is generated by the portable electronic device through the incoming call detection module; capturing navigation information of the navigation device through the information capturing module; utilizing the processing module to analyze the incoming call signal to correspondingly obtain incoming caller information; and determining whether or not navigation information is transformed into a traveling message based upon incoming caller information when the incoming call detection module detects the incoming call signal generated by the portable electronic device so that the traveling message is transmitted to the incoming caller.

The navigation device and the method for answering personal traveling information according to the invention have one or more advantages as the following:

(1) The navigation device and the method for answering personal traveling information according to the invention has the function of automatically answering traveling information to allow the incoming caller to receive the current condition of the driver.

(2) The navigation device and the method for answering personal traveling information according to the invention allow the driver to not answer the phone and also allow the incoming caller to obtain the current traveling information of the driver simultaneously so that the incoming caller can be prevented from anxiously waiting, and the driver can focus on driving.

### BRIEF DESCRIPTION OF THE DRAWINGS

FIG. 1 is a block diagram of a navigation device according to the invention;

FIG. 2 is a first schematic diagram of a navigation device according to a first embodiment of the invention;

FIG. 3 a second schematic diagram of a navigation device according to a first embodiment of the invention;

FIG. 4 is a schematic diagram of a navigation device according to a second embodiment of the invention;

FIG. 5 is a flow chart of a method for answering personal traveling information according to the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

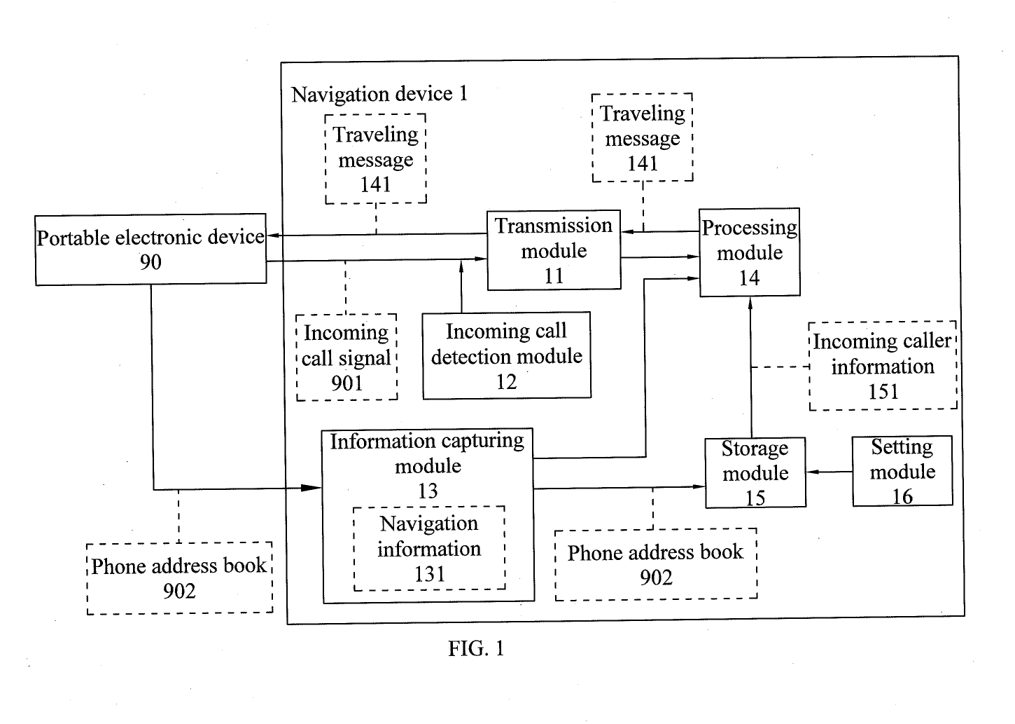

With reference to FIG. 1 for a block diagram of a navigation device according to the invention is depicted. As shown in FIG. 1, the navigation device 1 includes a transmission module 11, an incoming call detection module 12, an information capturing module 13, a processing module 14, a storage module 15 and a setting module 16. The navigation device 1 can be connected to a portable electronic device 90. The transmission module 11 can receive an incoming call signal 901 of an incoming caller generated by the portable electronic device 90. The incoming call detection module 12 can detect whether or not the portable electronic device 90 issues the incoming call signal 901. The information capturing module 13 can capture navigation information 131 of the navigation device 1. Navigation information 131 includes current locations, navigation departure points, navigation destination or destination arrival time. The storage module 15 can store incoming caller information 151. The setting module 16 can set a classification group of the incoming caller information 151 or transmission permission. The processing module 14 can be electronically connected to the information capturing module 13 and the transmission module 11. The processing module 14 can analyze the incoming call signal 901 to correspondingly obtain incoming caller information 151. When the incoming call detection module 151 detects the incoming call signal 901 of the portable electronic device 90, the processing module 14 determines whether or not navigation information 131 is converted into a traveling message 141 so that the traveling message 141 can be transmitted to the incoming caller.

When the navigation device 1 is connected to the portable electronic device 90, the information capturing module 13 captures a phone address book 902 of the portable electronic device 90 and transmits it to the storage module 15 to update incoming caller information 151. Moreover, the processing module 14 can determine whether or not the traveling message 141 is transmitted according to classification groups of incoming caller information 151 or transmission permission. The traveling message 141 includes current locations, navigation starting points, navigation destinations or estimated arrival time and can be multimedia messages such as script messages, figure messages, motion picture messages, audio messages or video messages.

It should be noted that the portable electronic device 90 can be smart phones or personal digital assistants having call functions and capable of connecting the navigation device 1. To further understand the technical features of the invention, the smart phone can, but not limited to, be taken as an example.

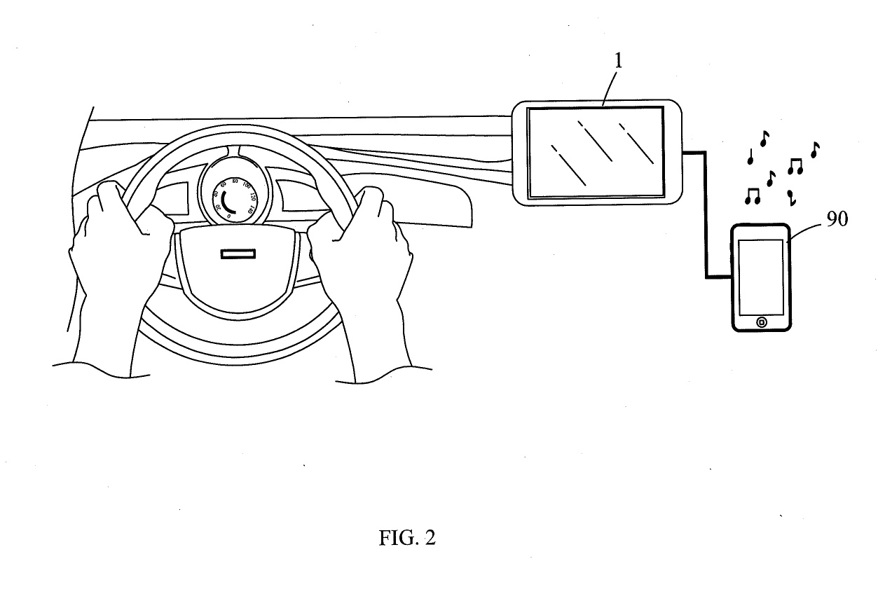

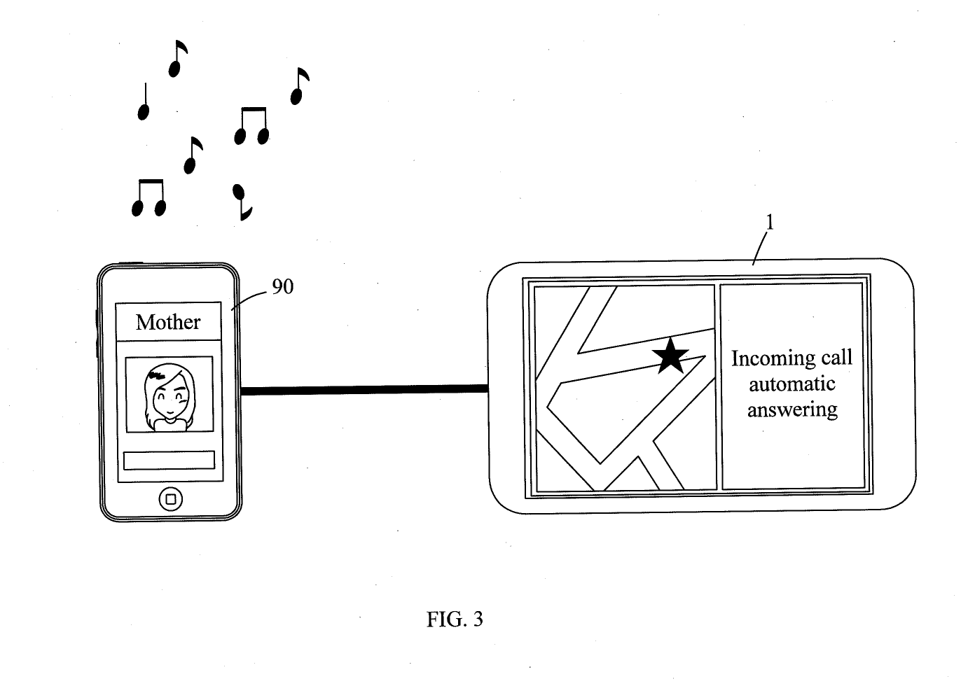

With reference to FIG. 2 and FIG. 3 for a first schematic diagram and a second schematic diagram of a navigation device according to a first embodiment invention are depicted. Generally, as shown in FIG. 2, when a driver drives a vehicle and hears a ringing of an incoming call or feels vibration of the smart phone, the navigation device 1 of the invention can solve the foregoing problems, and the driver can remain his/her safety driving so that the driver can be notified about the current personal traveling information of the incoming caller without answering the phone. When the driver uses the navigation device 1 of the invention, related maps, figures or information can be shown in the screen of the smart phone including current locations, navigation starting points, navigation destinations or estimated arrival time.

As shown in FIG. 3, the setting module can be utilized to set the classification groups of the incoming caller information or transmission permission. For example, the classification groups can be groups of families, colleagues, friends or classmates. In addition, the setting module can also set the transmission permission based upon the classification groups. For example, if the incoming callers are families (e.g. mothers), automatic answering are directly performed to transmit the traveling message. If they are classmates, the traveling message is not automatically transmitted. Further, the transmission permission of a single caller in incoming caller information can be set by the setting module. In the figure, an incoming call signal of the portable electronic device 90 is detected by the incoming call detection module of the navigation device 1. When the information capturing module captures navigation information, the processing module obtains information of an incoming caller to analyze navigation information that needs to be transformed into the traveling message. The traveling message then is transmitted to the incoming caller. The traveling message can be displayed with scripts, figures, motion pictures, audio or video, and its content can be the current location of the driver or the origination, the destination, or estimated arrival time.

Accordingly, with the navigation device 1 of the invention, when the incoming call comes, the navigation device 1 automatically issues the traveling message having navigation information to the incoming caller to achieve the function of automatically answering the traveling information.

It should be noted that when the navigation device 1 is connected to the portable electronic device 90, the phone address book of the portable electronic device 90 can be captured by the information capturing module and transmitted to the storage module of the navigation device 1 to update incoming caller information.

Next, according to the first embodiment, the invention further provides a second embodiment for detail depiction.

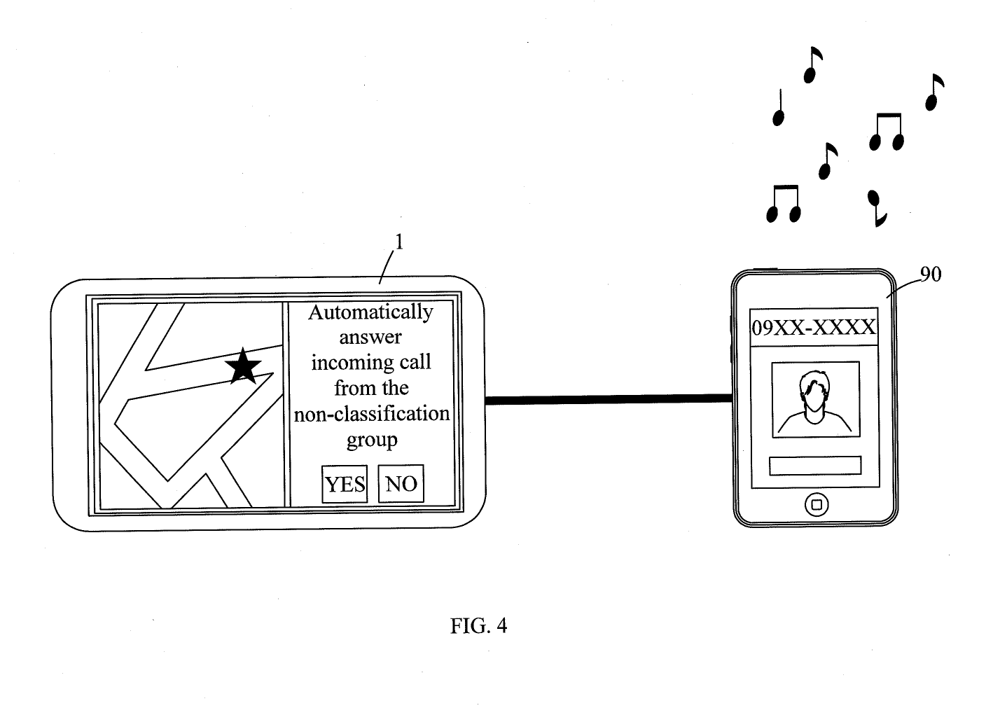

With reference to FIG. 4 for a schematic diagram of a navigation device according to a second embodiment of the invention is depicted. The navigation device 1 can be connected to the portable electronic device 90 that can, but not limited to, be a smart phone or a PDA having call function. As shown in the figure, the transmission module can receive the incoming call signal sent by the portable electronic device 90, and current navigation information can be captured by the information capturing module. Afterwards, the processing module is utilized to determine that when the incoming caller is not the contact person in the phone address book, navigation information is not automatically transformed into the traveling message that is directly transmitted. The driver can perform determination and select whether or not to automatically perform the answering. Accordingly, the navigation device 1 can also select whether or not the traveling message is transmitted to the incoming caller to prevent important incoming calls from being not answered.

It should be noted that the traveling message can, but not limited to, be services such as short message service (SMS) or multimedia messaging service (MMS).

Although a concept of a method for answering personal traveling information according to the invention has been depicted in detail during the process of illustrating the navigation device of the invention, the following flowchart is further provided to clarify the invention.

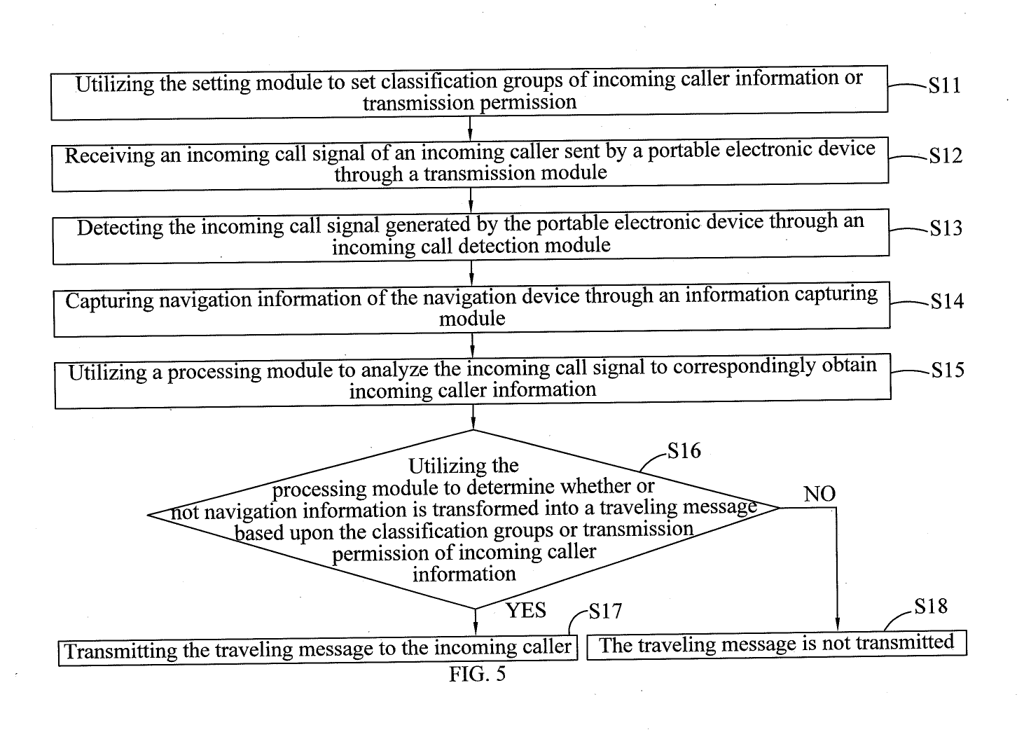

With reference to FIG. 5 for a flowchart of a method for answering personal traveling information according to the invention is depicted. The method for answering personal traveling information according to the invention is suitable for the navigation device. The navigation device herein has been depicted in detail, and there is no need to illustrate herein. As shown in FIG. 5, the method for answering personal traveling information of the navigation device includes the following steps:

In step S11, utilize the setting module to set classification groups of incoming caller information or transmission permission.

In step S12, receive an incoming call signal of an incoming caller sent by a portable electronic device through a transmission module.

In step S13, detect the incoming call signal generated by the portable electronic device through an incoming call detection module.

In step S14, capture navigation information of the navigation device through an information capturing module.

In step S15, utilize a processing module to analyze the incoming call signal to correspondingly obtain incoming caller information.

In step S16, utilize the processing module to determine whether or not navigation information is transformed into a traveling message based upon the classification groups or transmission permission of incoming caller information.

If the classification groups of the incoming caller set by the setting module is an automatic answering or to open the transmission permission of the incoming caller, a step S17 is performed, and the traveling message is transmitted to the incoming caller. Otherwise, a step S18 is performed, and the traveling message is not transmitted.

The detail depiction for the method for answering personal traveling information of navigation device according to the invention has been depicted in the foregoing navigation device of the invention, and there is no need to describe herein.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A navigation device connected to a portable electronic device, the navigation device comprising:
a transmission module for receiving an incoming call signal of an incoming caller sent by the portable electronic device;
an incoming call detection module for detecting whether or not the incoming call signal is generated by the portable electronic device;
an information capturing module for capturing navigation information of the navigation device and;
a processing module, electrically connected to the information capturing module and the transmission module, for analyzing the incoming call signal to correspondingly obtain incoming caller information, wherein when the incoming call detection module detects the incoming call signal generated by the portable electronic device, the processing module determines whether or not the navigation information is transformed into a traveling message based upon the incoming caller information so that the traveling message is transmitted to the incoming caller.

2. The navigation device as recited in claim 1, further comprising a storage module for storing incoming caller information.

3. The navigation device as recited in claim 2, wherein when the navigation device is connected to the portable electronic device, the information capturing module captures a phone address book of the portable electronic device and transmits the phone address book to the storage module to update incoming caller information.

4. The navigation device as recited in claim 1, further comprising a setting module for setting a classification group or a transmission permission of incoming caller information.

5. The navigation device as recited in claim 4, wherein the processing module determines whether or not the traveling message is transmitted according to the classification group of incoming caller information.

6. The navigation device as recited in claim 4, wherein the processing module determines whether or not the traveling message is transmitted according to the transmission permission of incoming caller information.

7. The navigation device as recited in claim 1, wherein the traveling message is a script message, a figure message, a motion picture message, an audio message or a video message.

8. The navigation device as recited in claim 1, wherein the navigation information comprises a current location, a navigation starting point, a navigation destination or an estimated arrival time.

9. A method for answering personal traveling information suitable for a navigation device, the navigation device comprising a transmission module, an information capturing module, an incoming call detection module and a processing module, the navigation device connected to a portable electronic device, the method for answering personal traveling information comprising:
receiving an incoming call signal of an incoming caller generated by the portable electronic device through the transmission module;
detecting whether or not the incoming call signal is generated by the portable electronic device through the incoming call detection module;
capturing navigation information of the navigation device through the information capturing module;
utilizing the processing module to analyze the incoming call signal to correspondingly obtain incoming caller information; and
determining whether or not the navigation information is transformed into a traveling message based upon the incoming caller information when the incoming call detection module detects the incoming call signal generated by the portable electronic device so that the traveling message is transmitted to the incoming caller.

10. The method for answering personal traveling information as recited in claim 9, wherein the navigation device further comprises a storage module and further comprising a step of:
utilizing the storage module to store incoming caller information.

11. The method for answering personal traveling information as recited in claim 10, further comprising steps:
capturing a phone address book of the portable electronic device through the information capturing module when the navigation device is connected to the portable electronic device; and
transmitting the phone address book to the storage module through the information capturing module to update the incoming caller information.

12. The method for answering personal traveling information as recited in claim 9, wherein the navigation device further comprises a setting module and further comprising a step of:
utilizing the setting module to set a classification group or a transmission permission of the incoming caller information.

13. The method for answering personal traveling information as recited in claim 12, further comprising a step of:
determining whether or not the traveling message is transmitted through the processing module based upon the classification group of incoming caller information.

14. The method for answering personal traveling information as recited in claim 12, further comprising a step of:
determining whether or not the traveling message is transmitted through the processing module based upon the transmission permission of incoming caller information.

15. The method for answering personal traveling information as recited in claim 9, wherein the traveling message is a script message, a figure message, a motion picture message, an audio message or a video message.

16. The method for answering personal traveling information as recited in claim 9, wherein the navigation information comprises a current location, a navigation starting point, a navigation destination or an estimated arrival time.
